(19) United States
(12) Patent Application Publication
(10) Pub. No.: US 2021/0310698 A1
(43) Pub. Date: Oct. 7, 2021

(54) Instantaneous Water Heater

(71) Applicant: Xiamen Cheari Eco Technology Co., Ltd, Xiamen (CN)

(72) Inventor: Quanduo HOU, Xiamen (CN)

(21) Appl. No.: 16/840,235

(22) Filed: Apr. 3, 2020

(51) Int. Cl. F24H 9/20; F24H 1/10; H05B 1/02

(52) U.S. Cl. CPC F24H 9/2028; F24H 1/0018; H05B 1/0297; F24H 1/101

(57) ABSTRACT

An instantaneous water heater is provided. The instantaneous water heater comprises a heating mechanism, comprising at least two heating components which are independent from each other; a pipeline mechanism, which is assembled on the heating mechanism; the pipeline mechanism comprises a heat exchange section for heat transfer with outside, a water inlet channel for supplying water to the heating components, and a water outlet channel for outputting hot water; the water inlet channel is at least partially surrounded by the heat exchange section; and a control mechanism, which is at least electrically connected to the heating mechanism. The heat exchange section is in contact with the control mechanism to dissipate heat from the control mechanism.

### TECHNICAL FIELD

The disclosure relates to the technical field of water heater, and more particularly to an instantaneous water heater.

### BACKGROUND

Instantaneous water heater is a water heater capable of providing hot water quickly. It has the advantages of small size and fast heating speed, and is widely used in various fields.

At present, in order to be able to heat water more quickly, some instantaneous water heaters are provided with multiple heating mechanisms, and such instantaneous water heaters need to be provided with water inlet and outlet pipes for each heating mechanism. This will not only complicate the water inlet pipe of the instantaneous water heater, increase the production cost, but also require more welding which greatly increases the risk of water leakage.

### SUMMARY OF THIS INVENTION

The present disclosure provides an instantaneous water heater, aiming to solve the problems existed in the prior art.

The provided instantaneous water heater comprises:

a heating mechanism, comprising at least two heating components which are independent from each other;

a pipeline mechanism, which is assembled on the heating mechanism; the pipeline mechanism comprises a heat exchange section for heat transfer with outside, a water inlet channel for supplying water to the heating components, and a water outlet channel for outputting hot water; the water inlet channel is at least partially surrounded by the heat exchange section; the water inlet channel is provided with a plurality of inlet ports with the same number of the heating components, and each of the inlet ports is in communication with each of the heating components separately; and the water outlet channel is provided with a plurality of outlet ports with the same number of the heating components, and each of the outlet ports is in communication with each of the heating components separately;

a control mechanism, which is at least electrically connected to the heating mechanism;

the heat exchange section is in contact with the control mechanism to dissipate heat from the control mechanism.

In some embodiments, the pipeline mechanism comprises a first pipe, and a second pipe communicating with the first pipe; the second pipe comprises the heat exchange section, and is a tubular member made of metal.

In some embodiments, the water inlet channel is provided with a cold water inlet, and the water outlet channel is provided with a hot water outlet; the inlet ports, the outlet ports, and the hot water outlet are all arranged on the first pipe; the cold water inlet is arranged on the second pipe.

In some embodiments, the control mechanism comprises a PCB (printed circuit board), wherein the PCB comprises a thyristor, and the heat exchange section is in contact with the thyristor.

In some embodiments, the pipeline mechanism comprises a plurality of water-dispersing members with the same number of the heating components; the water-dispersing members are arranged within the inlet ports separately; and each of the water-dispersing members is comprises a water-dispersing cavity and a plurality of water-dispersing openings; the water-dispersing cavity is in communication with the water inlet channel, and the water-dispersing openings are arranged around a circumferential surface of the water-dispersing member, and are in communication with the water-dispersing cavity.

In some embodiments, the pipeline mechanism comprises a flow sensor arranged on the first pipe; the flow sensor is configured for detecting a water flow flowing into the heating components from the inlet ports.

In some embodiments, the pipeline mechanism comprises a first temperature sensor and a second temperature sensor arranged on the pipeline mechanism; the first temperature sensor is configured for detecting an inlet water temperature of the water from the water inlet channel; the second temperature sensor is configured for detecting an outlet water temperature of the water from the water outlet channel.

In some embodiments, the instantaneous water heater comprises a housing; the heating mechanism, the pipeline mechanism, and the control mechanism all are arranged within the housing; the cold water outlet and the hot water inlet are extended out of the housing.

The present disclosure has the following advantages.

In the instantaneous water heater of the present disclosure, a plurality of heating components can be connected through a pipeline mechanism, and cold water can be delivered to each heating component through a water inlet channel for heating. The hot water heated by each heating component can finally be collected in the water outlet channel and being output collectively. The instantaneous water heater in the present disclosure can arrange the water inlet and outlet for the multiple heating components at one time through the piping mechanism, which not only makes the water heater more well-organized in appearance, but also simplifies the process such as installation. The instantaneous water heater in the present disclosure also reduces the welding positions and joints, greatly reducing the risk of water leakage.

In addition, because heating components usually need to cooperate with high-power electronic components such as thyristors, such high-power electronic components generally have a large amount of heat. In view of the small size of the instantaneous water heater, it is not easy to dissipate heat generated by the high-power electronic components. However, in the present disclosure, the instantaneous water heater comprises a heat exchange section in contact with the control mechanism. The heat exchange section can cool down the temperature of the control mechanism because the heat exchange section is in contact with the water inlet channel, which is filled with cold water, in another side. In use of the heat exchange of the heat exchange section, the temperature of the control mechanism can be well controlled.

### BRIEF DESCRIPTION OF THE DRAWINGS

In order to specify the embodiments of the present disclosure, the accompanying drawings used in the embodiments will be briefly introduced below. It should be understood that the following drawings only show some embodiments of the present disclosure, and therefore should not be regarded as a limit on the scope of this disclosure. For those with ordinary skill in the art, equivalent drawings can be obtained based on these drawings without creative work.

FIG. 1 is a schematic diagram of the instantaneous water heater according to one embodiment of the present disclosure.

FIG. 2 is a schematic diagram of the instantaneous water heater (with the upper shell being hidden) according to one embodiment of the present disclosure.

FIG. 3 is a partial exploded view of the instantaneous water heater according to one embodiment of the present disclosure.

FIG. 4 is a schematic diagram of the pipeline mechanism in a first direction.

FIG. 5 is a schematic diagram of the pipeline mechanism in a second direction.

FIG. 6 is a cross-sectional diagram of the instantaneous water heater according to one embodiment of the present disclosure.

FIG. 7 is a schematic diagram of the water-dispersing member according to one embodiment of the present disclosure.

FIG. 8 is an electrical relationship diagram of the instantaneous water heater according to one embodiment of the present disclosure.

Character references in the drawings: 1, housing; 2, heating mechanism; 3, pipeline mechanism; 4, control mechanism; 5, heating component; 6, first pipe; 7, second pipe; 8, first temperature sensor; 9, second temperature sensor; 10, flow sensor; 11, PCB; 12, water inlet channel; 13, water outlet channel; 14, hot water outlet; 15, cold water inlet; 16, heat exchange section; 17, inlet port; 18, outlet port; 19, heating pipe; 20, water-dispersing member; 21—water-dispersing cavity; 22, water-dispersing opening; 23, line bank; 24, overheat protector; 25, relay; 26, thyristor.

### DETAILED DESCRIPTION OF THE DISCLOSURE

The present disclosure will be detailed described accompany with the drawings and embodiment below.

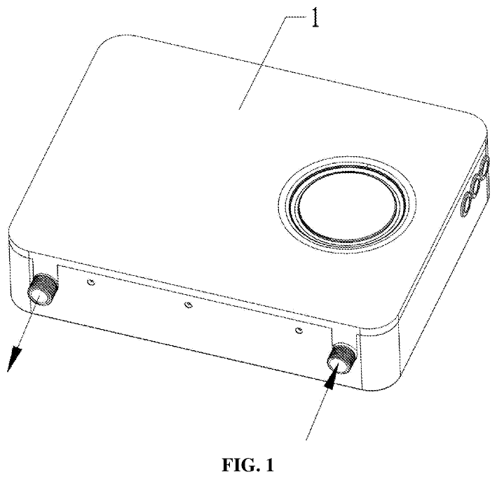

As shown in FIGS. 1-6, the embodiment provides an instantaneous water heater. The instantaneous water heater comprises a heating mechanism 2, a pipeline mechanism 3 and a control mechanism 4.

The heating mechanism 2 comprises three heating components 5 which are independent from each other.

The pipeline mechanism 3 comprises a water inlet channel 12 for supplying water to the heating components 5, a water outlet channel 13 for outputting hot water. The water inlet channel 12 is provided with a plurality of inlet ports 17 with the same number of the heating components 5, and each of the inlet ports 17 is in communication with each of the heating components 5 separately; and the water outlet channel 13 is provided with a plurality of outlet ports 18 with the same number of the heating components 5, and each of the outlet ports 18 is in communication with each of the heating components 5 separately. Be noted, in this embodiment, the pipeline mechanism 3 comprises a first pipe 6, and a second pipe 7 communicating with the first pipe 6. The heat exchange section 16 which can effectively heat exchange with outside is arranged on the second pipe 7. The water inlet channel 12 is partially surrounded by the heat exchange section 16.

The control mechanism 4 comprises a PCB 11. The PCB comprises a thyristor 26. The heat exchange section 16 is in contact with the thyristor 26.

In practical use, the second pipe 7 may be assembled with the first pipe 6, and then the first pipe 6 is installed on the heating mechanism 2. The mouth of the heating component 5 is tight fitting to the first pipe 6. Additionally, in the present embodiment, the second pipe is a tubular member made of metal. The first pipe 6 and the second pipe 7 can be attached in removable connection via a seal ring. In other embodiments, the first pipe 6 and the second pipe 7 may be made into one piece by an existing process, such as integral injection molding.

In the instantaneous water heater of the present embodiment, the three heating components 5 may be connected and in communication by the pipeline mechanism 3, and the water inlet channel 12 can guide the cold water to each of the heating components 5 for heating. The hot water produced by the heating components 5 may be collected to the water outlet channel 13 for discharging. In the instantaneous water heater, the pipeline mechanism 3 may configure the inlet ports and outlet ports of the three heating components 5 at a time. That would not only make the pipelines more well-organized in appearance, but also simplifies the assembling process. The decrement of welding positions and joints lower down the risk of water leakage.

In addition, because heating components 5 usually need to cooperate with high-power electronic components such as thyristors 26, such high-power electronic components generally have a large amount of heat. In view of the small size of the instantaneous water heater, it is not easy to dissipate heat generated by the high-power electronic components. However, in the present embodiment of the disclosure, the instantaneous water heater comprises a heat exchange section 16 in contact with the control mechanism 4. The heat exchange section 16 can cool down the temperature of the control mechanism 4 because the heat exchange section 16 is in contact with the water inlet channel 12, which is filled with cold water, in another side of the heat exchange section 16. In use of the heat exchange of the heat exchange section 16, the temperature of the control mechanism 4 can be well controlled.

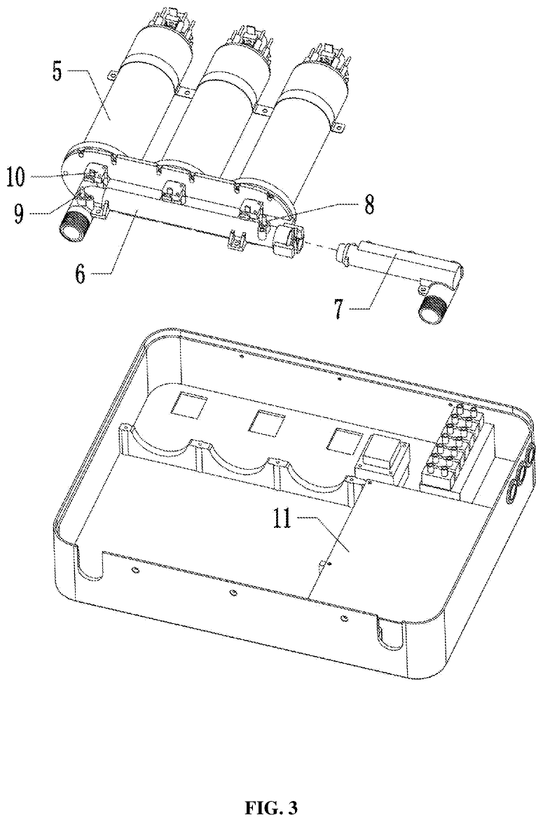

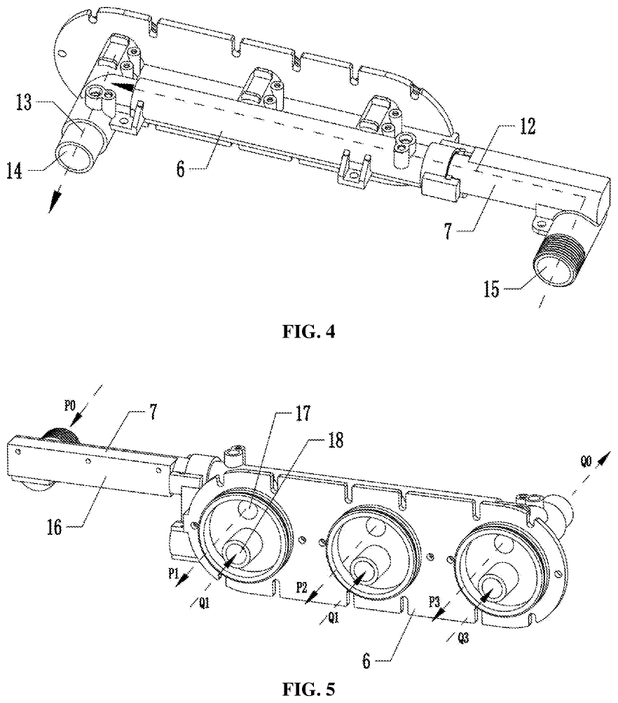

As shown in FIGS. 4-5, in the embodiment, the water inlet channel 12 comprises a cold water inlet 15. The water out channel 13 is provided with a hot water outlet 14. The inlet ports 17, the outlet ports 18, and the hot water outlet 14 are all arranged on the first pipe 6. The cold water inlet 15 is arranged on the second pipe 7. Further shown in FIG. 3, in the embodiment, the pipeline mechanism 3 comprises three flow sensors 10 on the first pipe 6. The three flow sensors 10 may detect water flow that flowing into the three heating components 5 from the inlet ports 17 separately. Furthermore, the pipe mechanism 3 further comprises a first temperature sensor 8 and a second temperature sensor 9 arranged on the pipeline mechanism 3. The first temperature sensor 8 and the second temperature sensor 9 are separately located on the pipe body of the water inlet channel 12 and the water outlet channel 13. The first temperature sensor 8 is configured for detecting the water temperature of the intake water from the water inlet channel 12. The second temperature sensor 9 is configured for detecting the water temperature of the outtake water from the water outlet channel 13. The flow sensor 10, the first temperature sensor 8 and the second temperature sensor 9 are electrically connected to the PCB 11, respectively.

As shown in FIG. 5, the water flow P0 from the cold water inlet will be divided to be multiple water flows P1, P2 and P3 for flowing into the three heating components. The hot water from the three heating components flows into the water outlet channel 13 via Q1, Q2 and Q3, and at last collectively form Q0 to be discharged by the hot water ports 14.

Furthermore, as shown in FIG. 8 which shows the electrical relationship of the instantaneous water heater, the control mechanism 4 of the present embodiment further comprises a line bank 23, an overheat protector 24, a relay 25 and etc. The heating component 5 comprises a heating pipe 19 for heating the water. The line bank 23, the overheat protector 25, the relay, and the thyristor 26 are equivalent to those in the prior art, and will not be repeated here.

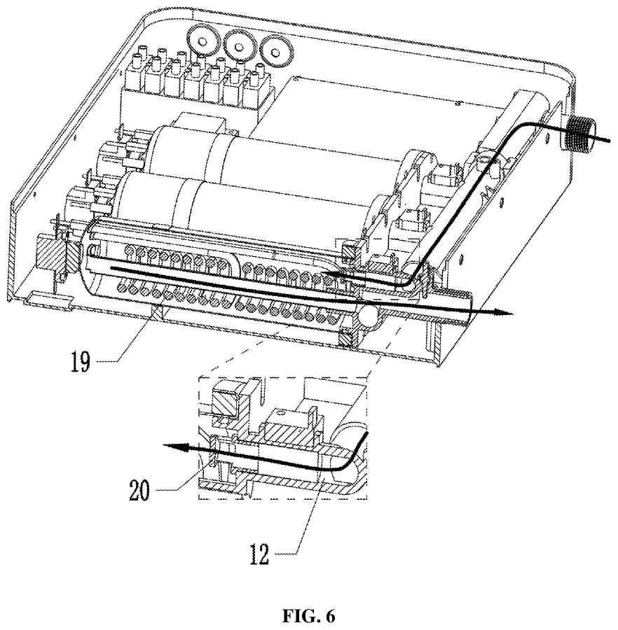

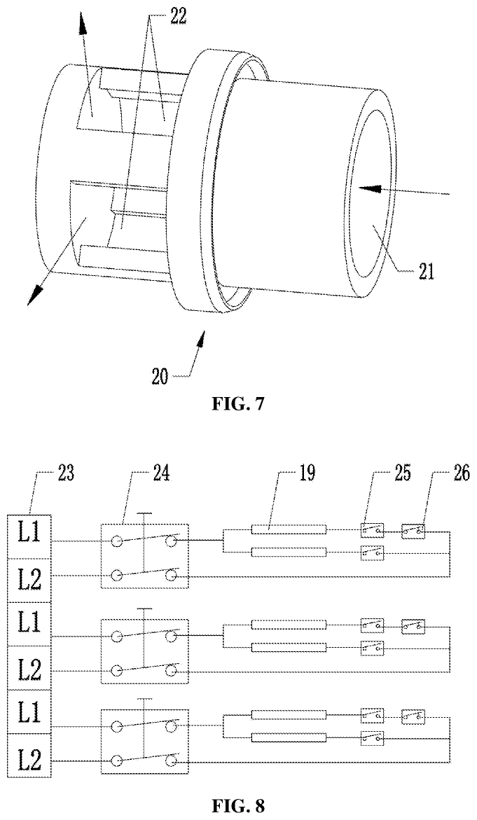

As shown in FIGS. 6 and 7, in the present embodiment, the pipeline mechanism three water-dispersing members 20 with the same number of the heating components 5. The water-dispersing members 20 are arranged within the inlet ports 17 separately; and each of the water-dispersing members 20 is comprises a water-dispersing cavity 21 and a plurality of water-dispersing openings 22. The water-dispersing cavity 21 is in communication with the water inlet channel 12, and the water-dispersing openings 22 are arranged around a circumferential surface of the water-dispersing member 20, and are in communication with the water-dispersing cavity 21. When the water from the water inlet channel 12 enters the water-dispersing cavity 21, the water will continue to flow into the heating cavity within the heating component 5 from the multiple evenly-arranged water-dispersing openings 22. The water-dispersing member 20 can play the role to evenly disperse the to-be-heated water from the water inlet channel into the heating cavity within the heating component 5, which is benefit for the heating component 5 to heat the water. Additionally, as shown in FIG. 6, the water-dispersing located at the inlet port 17 may also be a support for the secure of flow sensor 10.

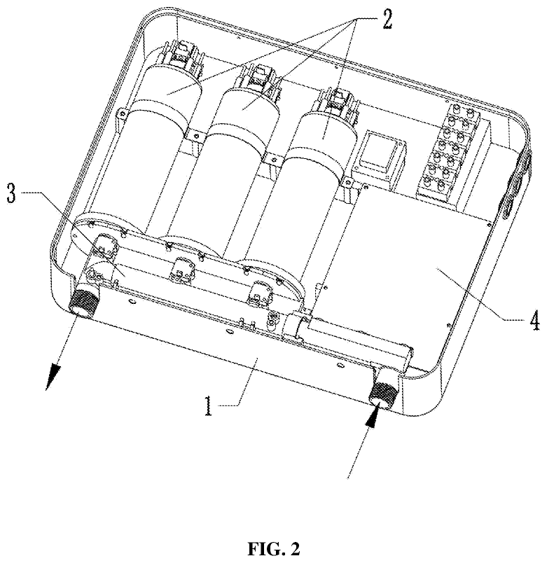

As shown in FIG. 1, FIG. 2 and FIG. 3, the instantaneous water heater comprises a housing 1. The housing 1 comprises a upper shell and a lower shell. A mounting cavity is formed between the upper shell and the lower shell. The heating mechanism 2, the pipeline mechanism 3 and the control mechanism 4 all are arranged within the amounting cavity. The cold water inlet 15 and the hot water outlet 14 are extended out from the housing 1.

In the instantaneous of the present disclosure, the first pipe 6 and the second pipe 7 may be pre-installed before use. The use of the first pipe 6 and the second pipe 7 may configure the inlet/outlet ports of multiple heating components 5. Such arrangement makes the inlet/outlet pipelines more well-organized in appearance, and also simplifies the installation process. The instantaneous water heater in the present disclosure also reduces the welding positions and joints, greatly reducing the risk of water leakage. Furthermore, the instantaneous water heater comprises a heat exchange section 16 which can cool down the related high-power electronical components on the control mechanism 4. The cold water filled in the water inlet channel 12 can used to cool down the related high-power electronical components via heat exchange. By doing so, the instantaneous water heater of the present disclosure would have a great heat dissipation within the small size. Additionally, the heat generated by the control mechanism 4 can also be used to lightly preheat the cold water in the water inlet channel 12 to a certain extent, thereby improving the energy efficiency utilization of the instantaneous water heater.

The above descriptions are merely preferred embodiments of the present disclosure, and are not intended to limit the present invention. For those skilled in the art, the present disclosure may have various modifications and changes. Any modification, equivalent replacement, and improvement made within the spirit and principle of the present disclosure shall be included in the protection scope of the present invention.

What is claimed is:

1. An instantaneous water heater, comprising:
a heating mechanism, comprising at least two heating components which are independent from each other;
a pipeline mechanism, which is assembled on the heating mechanism; the pipeline mechanism comprises a heat exchange section for heat transfer with outside, a water inlet channel for supplying water to the heating components, and a water outlet channel for outputting hot water; the water inlet channel is at least partially surrounded by the heat exchange section;
the water inlet channel is provided with a plurality of inlet ports with the same number of the heating components, and each of the inlet ports is in communication with each of the heating components separately; and the water outlet channel is provided with a plurality of outlet ports with the same number of the heating components, and each of the outlet ports is in communication with each of the heating components separately; and
a control mechanism, which is at least electrically connected to the heating mechanism;
wherein the heat exchange section is in contact with the control mechanism to dissipate heat from the control mechanism.

2. The instantaneous water heater according to claim 1, wherein the pipeline mechanism comprises a first pipe, and a second pipe communicating with the first pipe; the second pipe comprises the heat exchange section, and is a tubular member made of metal.

3. The instantaneous water heater according to claim 2, wherein the water inlet channel comprises a cold water inlet, and the water outlet channel comprises a hot water outlet;
the inlet ports, the outlet ports and the hot water outlet are all arranged on the first pipe; and
the cold water inlet is arranged on the second pipe.

4. The instantaneous water heater according to claim 1, wherein the control mechanism comprises a PCB (printed circuit board), wherein the PCB comprises a thyristor, and the heat exchange section is in contact with the thyristor.

5. The instantaneous water heater according to claim 1, wherein the pipeline mechanism comprises a plurality of water-dispersing members with the same number of the heating components; the water-dispersing members are arranged within the inlet ports separately;
each of the water-dispersing members is comprises a water-dispersing cavity and a plurality of water-dispersing openings; the water-dispersing cavity is in communication with the water inlet channel, and the water-dispersing openings are arranged around a circumferential surface of the water-dispersing member, and are in communication with the water-dispersing cavity.

6. The instantaneous water heater according to claim 2, wherein the pipeline mechanism comprises a flow sensor arranged on the first pipe; the flow sensor is configured for detecting a water flow flowing into the heating components from the inlet ports.

7. The instantaneous water heater according to claim 2, wherein the pipeline mechanism comprises a first temperature sensor and a second temperature sensor arranged on the pipeline mechanism; the first temperature sensor is configured for detecting an inlet water temperature of the water from the water inlet channel; the second temperature sensor is configured for detecting an outlet water temperature of the water from the water outlet channel.

8. The instantaneous water heater according to claim 2, wherein the instantaneous water heater comprises a housing; the heating mechanism, the pipeline mechanism, and the control mechanism all are arranged within the housing; the cold water outlet and the hot water inlet are extended out of the housing.
